(19) United States
(12) Patent Application Publication
(10) Pub. No.: US 2025/0225527 A1
(43) Pub. Date: Jul. 10, 2025

(54) FAST ANTI-MONEY LAUNDERING DETECTION METHOD BASED ON TRANSACTION GRAPH

(71) Applicant: TONGJI UNIVERSITY, Shanghai (CN)

(72) Inventors: Changjun Jiang, Shanghai (CN); Dawei Cheng, Shanghai (CN); Yujia Ye, Shanghai (CN)

(73) Assignee: TONGJI UNIVERSITY, Shanghai (CN)

(21) Appl. No.: 19/093,154

(22) Filed: Mar. 27, 2025

Related U.S. Application Data
(63) Continuation-in-part of application No. 18/038,988, filed on May 26, 2023.

(30) Foreign Application Priority Data
Dec. 14, 2021 (CN) 202111528301.8

(51) Int. Cl. G06Q 20/40; G06N 3/04

(52) U.S. Cl. CPC G06Q 20/4016; G06N 3/04

(57) ABSTRACT

The present invention relates to a fast anti-money laundering detection method based on a transaction graph, comprising: obtaining transaction data flows and constructing a directed graph structure to form a transaction graph; performing preliminary determination on the transaction graph, wherein if hit, the transaction is blocked, otherwise the transaction graph is sent to a graph neural network based on location information; performing feature learning according to a transaction feature of each node and aggregating a node feature and a full graph feature; performing prediction on a transaction between nodes according to the features, wherein if there is a high risk, an expert estimation is performed and the transaction is sent to a historical transaction database, and if there is a low risk, a transaction result is recorded and sent to the historical transaction database; and updating the network by the historical transaction database according to the transaction result.

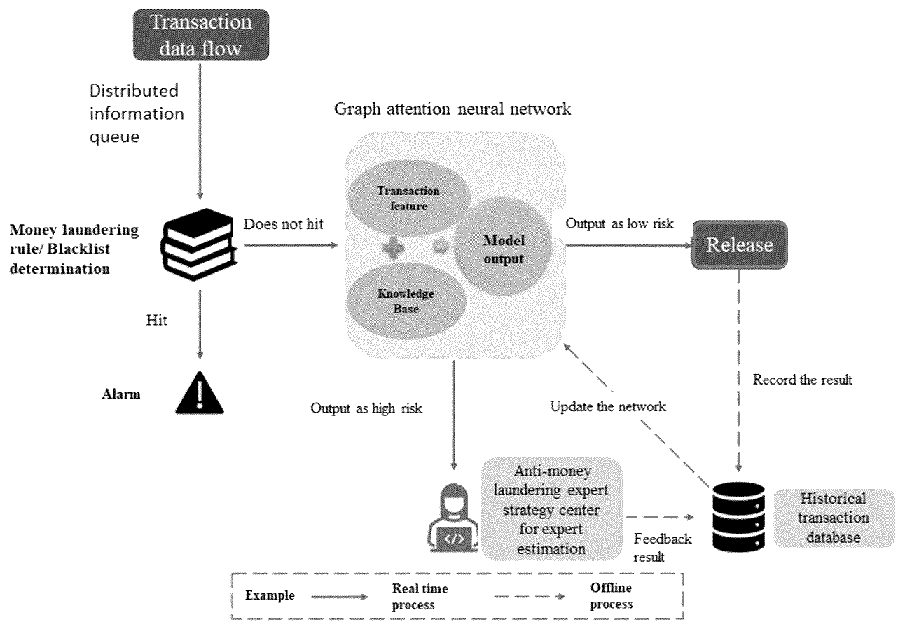

### CROSS-REFERENCE TO RELATED APPLICATION

This present application is a continuation-in-part application of and claims the priority benefit of U.S. application Ser. No. 18/038,988, filed on May 26, 2023, now pending. The prior U.S. application Ser. No. 18/038,988 is a 371 of international application of PCT application serial no. PCT/CN2022/106409, filed on Jul. 19, 2022, which claims the priority benefit of China application serial no. 202111528301.8, filed on Dec. 14, 2021. The entirety of each of the above-mentioned patent applications is hereby incorporated by reference herein and made a part of this specification.

### FIELD OF TECHNOLOGY

The present invention relates to the technical field of transaction detection, and in particular, to a fast anti-money laundering detection method based on a transaction graph.

### BACKGROUND

For decades, money laundering has been a major criminal activity within financial computing systems. In today's technology-driven society, criminals are using every possible means at their disposal to launder the ill-gotten money from their illegal activities. With the development of technology, the dynamic nature of the information system has reduced the effectiveness of the existing money laundering detection mechanism, so the process of money laundering crime is more covert, and the money laundering methods are more complex, intelligent and organized, which brings new problems and challenges to conventional anti-money laundering supervision systems.

As the primary goal of anti-money laundering supervision, anomaly detection has become the focus of current research. At present, the main challenge for abnormal transaction detection is to build effective rules and models from massive and heterogeneous transaction data to make the anti-money laundering detection positioning more rapid and accurate, so as to achieve the purpose of effective financial market security supervision. Therefore, it is a trend to break the convention thinking of anti-money laundering supervision and build a data-based intelligent anti-money laundering supervision through artificial intelligence and big data analysis. Through reference search in the existing technologies, it is found that the detection of abnormal transactions in the context of anti-money laundering mostly focuses on the detection of single transaction or single node. For example, in the Chinese patent “Method and system for detecting money laundering transactions in complex associated transactions” (with the authorization number of CN112508705A), it is proposed to establish a recurrent neural network model to collect a plurality of transaction data that are not known whether it is money laundering, and the transaction data are input into a trained recurrent neural network model in turn to get the determination result of whether it is money laundering. In the Chinese patent “Intelligent suspicious transaction monitoring method based on semi-supervised graph neural network” (with the authorization number of CN110400220A), it is proposed to input individual transaction features of high-risk density capital transaction network and accounts into a semi-supervised graph neural network, and the semi-supervised graph neural network outputs the risk probability of capital transaction of the account, and determines the account with the risk probability of capital transaction higher than a first threshold as the account with high money laundering risk. The existing relevant research has made good progress in improving the accuracy of abnormal transaction detection, but there are still two major defects: first, since the real-time transaction graph is constantly dynamic, the existing anti-money laundering detection method based on graph neural network cannot accurately monitor the dynamic transaction graph in real time, and second, since the existing anti-money laundering scheme focuses on the analysis of single node or single transaction, it is difficult to fully evaluate the impact of the relationship, that is, the potential social network relationship in the transaction graph, on the risk.

### SUMMARY

The purpose of the present invention is to provide a fast anti-money laundering detection method based on a transaction graph to overcome the defects of the above existing technologies that cannot accurately monitor the dynamic transaction graph in real time and focus on analyzing a single node or a single transaction.

The purpose of the present invention can be realized through the following technical solutions:

A fast anti-money laundering detection method based on a transaction graph, including the following steps:
step S1, obtaining transaction data flows of a plurality of accounts and constructing a directed graph structure according to the transaction data flows to form a transaction graph;
step S2, performing preliminary determination on the transaction graph by taking a blacklist and a money laundering rule as a benchmark, where if the transaction graph conforms to the blacklist and the money laundering rule, then the transaction is blocked, and if the transaction graph does not conform to the blacklist and the money laundering rule, then the transaction graph is sent to a graph neural network based on location information;
step S3, performing feature learning, by the graph neural network based on location information, according to a transaction feature of each node in the transaction graph, updating an unmarked transaction feature, and aggregating a node feature and a full graph feature;
step S4, performing prediction, by the processor, executing a graph attention model in the graph neural network, on a transaction between nodes according to the node feature and the full graph feature, where if a prediction result is of an order of money laundering transaction is higher than or equal to a threshold value, transaction information of the transaction is sent to an anti-money laundering expert strategy center and the transaction information is presented in time through a hardware display interface, and a feedback result is sent to a historical transaction database in time; and if the prediction result is of the order of money laundering transaction is lower than the threshold value, then a corresponding transaction result is recorded and sent to the historical transaction database; and
step S5, updating, by the historical transaction database, the graph neural network according to the high-risk and low-risk transaction results, searching a potential transmission chain of a money laundering transaction thereby detecting a plurality of illegal nodes involved in a same money laundering case.

In the transaction graph, a node denotes a user or a merchant and an edge denotes a transaction.

The transaction graph uses an Elliptic data set as the standard for collecting transaction features.

Further, in each transaction of the transaction graph, 166 features are collected, of which 94 features are local information of a transaction account and the other 72 features are aggregated transaction data from forward/backward aggregate transaction information of a central node as aggregation features.

Further, the local information of the transaction account includes time step, transaction fee, input/output number, output volume and a plurality of pieces of sum data, and the transaction data corresponding to the aggregation feature includes maximum value, minimum value, and standard deviation.

The directed graph is denotes as G=((V, M), E), where V={vᵤ₁, vᵤ₂, vᵤ₃, . . . , vᵤₙ} denotes a series of transaction users, M={vₘ₁, vₘ₂, vₘ₃, . . . , vₘₙ} denotes a series of merchants, and E={e₁, e₂, e₃, . . . , e_{|E|}} denotes a series of transactions (when a transaction occurs between a user and a merchant, an edge is created between two nodes).

The formula used for updating an edge feature in the graph neural network at step S5 is:

e′ᵢⱼ=NN(eᵢⱼ, vᵢ, mⱼ, v_{g})

where e′ᵢⱼ denotes an edge feature after update, NN denotes a neural network including two fully connected layers with an activation function of ReLu, eᵢⱼ denotes an edge feature before update, v_{g} denotes a feature vector corresponding to a directed graph G of the transaction graph, vᵢ and mⱼ denotes nodes in the directed graph, of which vᵢ∈V, mⱼ∈M.

Further, the edge feature eᵢⱼ denotes the edge between the nodes i and j, and the corresponding feature vector includes transaction times and transaction location.

The formula used for updating a node feature in the graph neural network at step S5 is:

v′ᵤᵢ=NN(Σ_{j∈N}_{ᵢ}eᵢⱼ, vᵤᵢ, v_{g})

v′ₘᵢ=NN(Σ_{j∈N}_{ᵢ}eᵢⱼ, vₘᵢ, v_{g})

where v′ᵤᵢ and v′ₘᵢ denote a user node feature and a merchant node feature after update, respectively; vᵤᵢ and vₘᵢ denote a user node feature and a merchant node feature before update, respectively; and Nᵢ denotes all edges connected to the node vᵢ.

The formula used for updating a feature vector of the directed graph G in the graph neural network at step S5 is:

V′_{g}=NN (v̅ᵤ̅, v̅ₘ̅, ē, v_{g})

Where v′_{g} denotes a feature vector of the directed graph G after update, v̅ᵤ̅ denotes the mean of all user node features in the directed graph, v̅ₘ̅ denotes the mean of all merchant node features in the directed graph, and ē denotes the mean of all edges in the directed graph.

The graph neural network based on location information includes an attention mechanism based graph convolutional network, accepting X∈ [symbol] ^{N}^{_{1*}}^{N}^{₂} as an input, where X denotes an edge feature constructed in the graph neural network, N₁ denotes the dimension of a temporal window, N₂ denotes the feature dimension of v_{f}, v_{f} denotes the feature vector obtained by concatenating v′_{g}, v′ᵤᵢ, v′ₘᵢ, and e′ᵢⱼ. That is, a feature vector v_{f} is constructed for each temporal window that contains information such as transaction features, relationship features between graphs, etc.

Further, the graph convolutional network is provided with a temporal attention layer to better capture the pattern of transaction changing over time, specifically shown in the following formula:

$$rept = {\sum }_{t = 1}^{{N}_{1}} {β}_{t} χ ( t , : )$$

$${β}_{t} = \frac{exp ( 1 - {λ}_{1} ) * ( N N ( {W}_{n} , χ ( t , : ) ) )}{{\sum }_{i = 1}^{{N}_{1}} exp ( 1 - {λ}_{1} ) * ( N N ( {W}_{n} , χ ( i , : ) ) )}$$

where β_{t,j} denotes the weight parameter of the temporal window t, NN denotes a feed forward network, Wₙ denotes a parameter that needs to be trained for the temporal attention network, λ₁ denotes a process parameter, and rept denotes an output result of each transaction in the graph convolutional network. Compared with one-dimensional convolution layer, two-dimensional convolution layer can make better use of the temporal information in features, so a 2D convolution layer and a 2D pooling layer are connected behind the attention network.

Further, the graph neural network based on location information is provided with a prediction layer, an output of the prediction layer is a fraud probability of the transaction, and the prediction layer is provided with a loss function L, specifically shown in the following formula:

$$L = \frac{1}{N} {\sum }_{i = 1}^{N} {y}_{i} log ( detect ( {rept}_{i} ) ) + {λ}_{2} ( 1 - {y}_{i} ) log ( 1 - detect ( {rept}_{i} ) )$$

where N denotes the number of the nodes, yᵢ denotes the weight parameter, and λ₂ denotes the weight of positive and negative samples, reptᵢ denotes the feature vector of each transaction in the temporal attention layer, and detect(reptᵢ) denotes the prediction layer, two layers of ReLu and one layer of sigmoid are used to complete the output of prediction results and SGD is used for training.

### BRIEF DESCRIPTION OF THE DRAWINGS

Figure is a schematic diagram of a flow chart the present invention

### DETAILED DESCRIPTION OF THE EMBODIMENTS

The present invention is described in detail below with reference to the accompanying drawings and specific embodiments. The present embodiment is implemented on the premise of the technical scheme of the present invention, and gives the detailed implementation method and specific operation process, but the protection scope of the present invention is not limited to the following embodiment.

In the following embodiment, the steps may be executed by a processor of a fast anti- money laundering detection system. The processor is, for example, a central processing unit (CPU), or other programmable general purpose or special purpose microprocessor, a digital signal processor (DSP), programmable controller, Application Specific Integrated Circuit (ASIC) or other similar components or a combination of the above components, and the disclosure is not limited thereto.

A memory is provided in the fast anti-money laundering detection system. The memory is used for storing various codes and data required for the fast anti-money laundering detection. The memory may be coupled to the memory. In particular, the memory can be used to store values such as threshold for high risk detection. The memory may also store various of models or modules for fast anti-money laundering detection. The memory is, for example but not limited to, any type of static or dynamic random access memory (RAM), read-only memory (ROM), flash memory, a hard disk drive (HDD), a solid state drive (SSD) or any similar components or a combination of the above components, and the disclosure is not limited thereto.

### Embodiment

As shown in figure, a fast anti-money laundering detection method based on a transaction graph, including the following steps:
step S1, obtaining transaction data flows of a plurality of accounts and constructing a directed graph structure according to the transaction data flows to form a transaction graph;
step S2, performing preliminary determination on the transaction graph by taking a blacklist and a money laundering rule as a benchmark, where if the transaction graph conforms to the blacklist and the money laundering rule, then the transaction is blocked, and if the transaction graph does not conform to the blacklist and the money laundering rule, then the transaction graph is sent to a graph neural network based on location information;
step S3, performing feature learning, by the graph neural network based on location information, according to a transaction feature of each node in the transaction graph, updating an unmarked transaction feature, and aggregating a node feature and a full graph feature;
step S4, performing prediction, by a graph attention model in the graph neural network, on a transaction between nodes according to the node feature and the full graph feature, where if a prediction result is of a value higher than or equal to a threshold, it is determined as high risk, transaction information of the transaction is sent to an anti-money laundering expert strategy center, the transaction information may be presented through a hardware display interface for expert estimation and a feedback result is sent to a historical transaction database, and if the prediction result is of a value lower than a threshold, it is determined as low risk, then a corresponding transaction result is recorded and sent to the historical transaction database, where the threshold may be determined as a number larger than 80. In one of an embodiment, if the prediction result is of a value higher than or equal to the threshold, a feedback is provided by a processor executing a risk estimation module stored in a memory; and

As a prediction result is of a value higher than or equal to a threshold, the transaction is blocked, and other transaction histories of other accounts of the user are also checked. Moreover, in one of the embodiment, the account is blocked for all the financial transactions. In one other embodiment, an alarm of voice signal would be initiated as the prediction result is of a value higher than or equal to the threshold so that bank clerks would be announced. In one other embodiment, an e-mail of notifying that the transaction is suspected of money laundering is sent to the account owner and the bank.

In one of the embodiment, the prediction result may be determined by adding numbers of factors. Table 1 shows an example of factors correspond to quantitative score.

TABLE 1

| Factor | Yes | No |
|---|---|---|
| Anonymous transactions | 50 | 0 |
| 5 transactions with same account in a single day | 10 | 0 |
| 10 transactions with same account in a single day | 20 | 0 |
| A single amount is greater than 500,000 | 10 | 0 |
| A single amount is greater than 1,000,000 | 10 | 0 |

If target account has conducting transaction to an anonymous account, had conducted transactions 11 times a day and a single amount is 800,000, the score is 90 (50+10+20+10). Then the prediction result of the transaction of target account is 90, which is larger than the threshold of 80. The transaction is determined as high risk.
step S5, updating, by the historical transaction database, the graph neural network according to the high-risk and low-risk transaction results, searching a potential transmission chain of a money laundering transaction thereby detecting a plurality of illegal nodes involved in a same money laundering case.

In transaction graph, a node denotes a user or a merchant and an edge denotes a transaction.

The transaction graph uses an Elliptic data set as the standard for collecting transaction features.

In each transaction of the transaction graph, 166 features are collected, of which 94features are local information of a transaction account and the other 72 features are aggregated transaction data from forward/backward aggregate transaction information of a central node as aggregation features.

The local information of the transaction account includes time step, transaction fee, input/output number, output volume and a plurality of pieces of sum data, and the transaction data corresponding to the aggregation feature includes maximum value, minimum value, and standard deviation.

The directed graph is denotes as G=((V, M),E), where V={vᵤ₁, vᵤ₂, vᵤ₃, . . . , vᵤₙ} denotes a series of transaction users, M={vₘ₁, vₘ₂, vₘ₃, . . . , vₘₙ} denotes a series of merchants, and E={e₁, e₂, e₃, . . . , e_{|E|}} denotes a series of transactions (when a transaction occurs between a user and a merchant, an edge is created between two nodes).

The formula used for updating an edge feature in the graph neural network step S5 is:

e′ᵢⱼ=NN(eᵢⱼ, vᵢ, mⱼ, v_{g})

where e′ᵢⱼ denotes an edge feature after update, NN denotes a neural network including two fully connected layers with an activation function of ReLu, eᵢⱼ denotes an edge feature before update, v_{g} denotes a feature vector corresponding to a directed graph G of the transaction graph, vᵢ and mᵢ denotes nodes in the directed graph, of which vᵢ∈V, mⱼ∈M.

The edge feature eᵢⱼ denotes the edge between the nodes i and j, and the corresponding feature vector includes transaction times and transaction location.

The formula used for updating a node feature in the graph neural network step S5 is:

v′ᵤᵢ=NN(Σ_{j∈N}_{ᵢ}eᵢⱼ, vᵤᵢ, v_{g})

v′ₘᵢ=NN(Σ_{j∈N}_{ᵢ}eᵢⱼ, vₘᵢ, v_{g})

where v′ᵤᵢ and v′ₘᵢ denote a user node feature and a merchant node feature after update, respectively; vᵤᵢ and vₘᵢ denote a user node feature and a merchant node feature before update, respectively; and Nᵢ denotes all edges connected to the node vᵢ.

The formula used for updating a feature vector of the directed graph G in the graph neural network step S5 is:

v′_{g}=NN(v̅ᵤ̅, v̅ₘ̅, ē, v_{g})

Where v′_{g} denotes a feature vector of the directed graph G after update, v̅ᵤ̅ denotes the mean of all user node features in the directed graph, v̅ₘ̅ denotes the mean of all merchant node features in the directed graph, and ē denotes the mean of all edges in the directed graph.

The graph neural network based on location information includes an attention mechanism based graph convolutional network, accepting X∈ [symbol] ^{N}^{_{1*}}^{N}^{₂} as an input, where X denotes an edge feature constructed in the graph neural network, N₁ denotes the dimension of a temporal window, N₂ denotes the feature dimension of v_{f}, v_{f} denotes the feature vector obtained by concatenating v′_{g}, v′ᵤᵢ, v′ₘᵢ, and e′ᵢⱼ. That is, a feature vector v_{f} is constructed for each temporal window that contains information such as transaction features, relationship features between graphs, etc,

The graph convolutional network is provided with a temporal attention layer to better capture the pattern of transaction changing over time, specifically shown in the following formula:

$$rept = {\sum }_{t = 1}^{{N}_{1}} {β}_{t} χ ( t , : )$$

$${β}_{t} = \frac{exp ( 1 - {λ}_{1} ) * ( N N ( {W}_{n} , χ ( t , : ) ) )}{{\sum }_{i = 1}^{{N}_{1}} exp ( 1 - {λ}_{1} ) * ( N N ( {W}_{n} , χ ( i , : ) ) )}$$

where β_{t,j} denotes the weight parameter of the temporal window t, NN denotes a feed forward network, Wₙ denotes a parameter that needs to be trained for the temporal attention network, λ₁ denotes a process parameter, and rept denotes an output result of each transaction in the graph convolutional network. Compared with one-dimensional convolution layer, two-dimensional convolution layer can make better use of the temporal information in features, so a 2D convolution layer and a 2D pooling layer are connected behind the attention network.

The graph neural network based on location information is provided with a prediction layer, an output of the prediction layer is a fraud probability of the transaction, and the prediction layer is provided with a loss function L, specifically shown in the following formula:

$$L = \frac{1}{N} {\sum }_{i = 1}^{N} {y}_{i} log ( detect ( {rept}_{i} ) ) + {λ}_{2} ( 1 - {y}_{i} ) log ( 1 - detect ( {rept}_{i} ) )$$

where N denotes the number of the nodes, yᵢ denotes the weight parameter, and λ₂ denotes the weight of positive and negative samples, reptᵢ denotes the feature vector of each transaction in the temporal attention layer, and detect (reptᵢ) denotes the prediction layer, two slayers of ReLu and one layer of sigmoid are used to complete the output of prediction results and SGD is used for training.

In the present embodiment, there are two steps for the anti-money laundering detection: pre-access and post-monitoring. In pre-access, a blacklist and a money laundering rule are taken as a benchmark to determine whether a transaction order is fraud, and if the transaction is of high risk, then the transaction will be blocked directly. Post-monitoring refers to the use of the algorithmic model for predicting the probability of money laundering to predict the risk of transactions, and the transactions involving high probability of money laundering are handed over to experts for further determination.

During the specific implementation, the transaction data in the transaction graph will arrive in the form of distributed queues, and will be admitted in advance, and the GAT network will be used for prediction, and a memory database will be used to record these historical transaction data. If the prediction result shows that the order is a high-risk money laundering transaction, it shall be handed over to experts for determination, and the determination result will be returned to the historical database. The data in the historical database may play the role of offline update. On the one hand, the data may act on the GAT network, enabling the network to be updated in real time, and on the other hand, the data may help improve the rules of pre-access.

Compared with the prior art, the present invention has the following beneficial effects:

1. The present invention establishes features for the transaction of the knowledge graph at each temporal window in real time, fully taking into account the change of the transaction with time. Compared with the graph information that is difficult to capture in real time by the existing technology, the present invention effectively improves the accuracy of transaction monitoring. In addition, when using the model to predict the real world, the historical high-risk data is recorded through the historical transaction database and fed back to the network in real time, so that the network can be updated in time.

2. The present invention designs a graph neural network based on location information, which aims to aggregate the feature relationship of nodes and the whole graph. Compared with the existing technology, it is difficult to capture the potential relationship information in the graph, the present invention can discover the potential social relationship in the network, and improve the accuracy and coverage of the anti-money laundering detection results.

Further, it should be noted that the specific embodiments described in the present specification may be given different names, and the above content described in the present specification is only an example of the structure of the present invention. All equivalent alternatives or simple changes based on the structure, features and principles of the present invention are included in the scope of protection of the present invention. Those skilled in the art to which the present invention belongs may make various modifications or supplements to the specific examples described or adopt similar methods, and as long as they do not deviate from the structure of the present invention or go beyond the scope defined in the claims, they shall fall within the scope of protection of the present invention.

What is claimed is:

1. A fast anti-money laundering detection method based on a transaction graph, comprising the following steps:
step S1, obtaining, by a processor, transaction data flows of a plurality of accounts and constructing a directed graph structure according to the transaction data flows to form a transaction graph;
step S2, performing, by the processor, preliminary determination on the transaction graph by taking a blacklist and a money laundering rule as a benchmark, wherein if the transaction graph conforms to the blacklist and the money laundering rule, then the transaction is blocked in real time, and if the transaction graph does not conform to the blacklist and the money laundering rule, then the transaction graph is sent to a graph neural network based on location information;
step S3, performing, by the processor, feature learning, by the graph neural network based on location information, according to a transaction feature of each node in the transaction graph, updating an unmarked transaction feature, and aggregating a node feature and a full graph feature;
step S4, performing prediction, by the processor, executing a graph attention model in the graph neural network, on a transaction between nodes according to the node feature and the full graph feature, wherein if a prediction result is of an order of money laundering transaction is higher than or equal to a threshold value, transaction information of the transaction is sent to an anti-money laundering expert strategy center and the transaction information is presented in time through a hardware display interface, and a feedback result is sent to a historical transaction database in time; and if the prediction result is of the order of money laundering transaction is lower than the threshold value, then a corresponding transaction result is recorded and sent to the historical transaction database; and
step S5, updating, by the processor, the graph neural network according to the high-risk and low-risk transaction results based on the historical transaction database, searching a potential transmission chain of a money laundering transaction thereby detecting a plurality of illegal nodes involved in a same money laundering case,
wherein the formula used for updating an edge feature in the graph neural network at step S5 is:
e′ᵢⱼ=NN(eᵢⱼ, vᵢ, mⱼ, v_{g})
wherein e′ᵢⱼ denotes an edge feature after update, NN denotes a neural network comprising two fully connected layers with an activation function of ReLu, eᵢⱼ denotes an edge feature before update, v_{g} denotes a feature vector corresponding to a directed graph G of the transaction graph, vᵢ and mⱼ denotes nodes in the directed graph, of which vᵢ∈V, mⱼ∈M and V={vᵤ₁, vᵤ₂, vᵤ₃, . . . , vᵤₙ} denotes a series of transaction users and M={vₘ₁, vₘ₂, vₘ₃, . . . , vₘₙ} denotes a series of merchants,
wherein the formula used for updating a node feature in the graph neural network at step S5 is:
v′ᵤᵢ=NN(Σ_{j∈N}_{ᵢ}eᵢⱼ, vᵤᵢ, v_{g})
v′ₘᵢ=NN(Σ_{j∈N}_{ᵢ}eᵢⱼ, vₘᵢ, v_{g})
wherein v′ᵤᵢ and v′ₘᵢ denote a user node feature and a merchant node feature after update, respectively; vᵤᵢ and vₘᵢ denote a user node feature and a merchant node feature before update, respectively; and Nᵢ denotes all edges connected to the node vᵢ,
wherein the formula used for updating a feature vector of the directed graph G in the graph neural network at step S5 is:
v′_{g}=NN(v̅ᵤ̅, v̅ₘ̅, ē, v_{g})
wherein v′_{g} denotes a feature vector of the directed graph G after update, v̅ᵤ̅ denotes the mean of all user node features in the directed graph, v̅ₘ̅ denotes the mean of all merchant node features in the directed graph, and ē denotes the mean of all edges in the directed graph,
wherein the graph neural network based on location information comprises an attention mechanism based graph convolutional network, accepting X∈ [symbol] ^{N}^{_{1*}}^{N}^{₂} as an input, wherein X denotes an edge feature constructed in the graph neural network, N₁ denotes the dimension of a temporal window, N₂ denotes the feature dimension of v_{f}, v_{f} denotes the feature vector obtained by concatenating v′_{g}, v′ᵤᵢ, v′ₘᵢ, and e′ᵢⱼ,
wherein the graph convolutional network is provided with a temporal attention layer, specifically shown in the following formula:
$$rept = {\sum }_{t = 1}^{{N}_{1}} {β}_{t} χ ( t , : )$$
$${β}_{t} = \frac{exp ( 1 - {λ}_{1} ) * ( N N ( {W}_{n} , χ ( t , : ) ) )}{{\sum }_{i = 1}^{{N}_{1}} exp ( 1 - {λ}_{1} ) * ( N N ( {W}_{n} , χ ( i , : ) ) )}$$
wherein β_{t,j} denotes the weight parameter of the temporal window t, NN denotes a feed forward network, Wₙ denotes a parameter that needs to be trained for the temporal attention network, λ₁ denotes a process parameter, and rept denotes an output result of each transaction in the graph convolutional network.

2. The fast anti-money laundering detection method based on a transaction graph according to claim 1, wherein in the transaction graph, a node denotes a user or a merchant and an edge denotes a transaction.

3. The fast anti-money laundering detection method based on a transaction graph according to claim 2, wherein in each transaction of the transaction graph, 166 features are collected, of which 94 features are local information of a transaction account and the other 72 features are aggregated transaction data from forward/backward aggregate transaction information of a central node as aggregation features.

4. The fast anti-money laundering detection method based on a transaction graph according to claim 3, wherein the local information of the transaction account comprises time step, transaction fee, input/output number, output volume and a plurality of pieces of sum data, and the transaction data corresponding to the aggregation feature comprises maximum value, minimum value, and standard deviation.

5. The fast anti-money laundering detection method based on a transaction graph according to claim 1, wherein the graph neural network based on location information is provided with a prediction layer, an output of the prediction layer is a fraud probability of the transaction, and the prediction layer is provided with a loss function L, specifically shown in the following formula:
$$L = \frac{1}{N} {\sum }_{i = 1}^{N} {y}_{i} log ( detect ( {rept}_{i} ) ) + {λ}_{2} ( 1 - {y}_{i} ) log ( 1 - detect ( {rept}_{i} ) )$$
wherein N denotes the number of the nodes, yᵢ denotes the weight parameter, and λ₂ denotes the weight of positive and negative samples, reptᵢ denotes the feature vector of each transaction in the temporal attention layer, and detect (reptᵢ) denotes the prediction layer.
